(19) United States
(12) Patent Application Publication
(10) Pub. No.: US 2006/0074361 A1
(43) Pub. Date: Apr. 6, 2006

(54) Vibrator for constipation

(76) Inventor: Yahuda Zicherman, Bnaj-Brak (IL)

Correspondence Address: KENYON & KENYON LLP, ONE BROADWAY, NEW YORK, NY, 10004, US

(21) Appl. No.: 11/286,751

(22) Filed: Nov. 25, 2005

Related U.S. Application Data
(63) Continuation of application No. 10/892,621, filed on Jul. 15, 2004, now abandoned.
Application No. 10/892,621 is a continuation of application No. 09/705,389, filed on Nov. 2, 2000, now abandoned.

(30) Foreign Application Priority Data
Apr. 11, 1999 (IL) 132760

(51) Int. Cl. A61H 7/00

(52) U.S. Cl. 601/144; 601/147; 601/143

(57) ABSTRACT

An apparatus and method for treatment of constipation and/or effectuating the release of intestinal gases is provided. The apparatus includes a support member having at least one vibratory element attached to the support member. An actuator, which is operatively attached to the vibratory element, moves the vibratory element in a motion. The motion is operative to promote peristaltic movements of gastrointestines so as to ease constipation and to effectuate the release of gases in a patient.

### BACKGROUND OF THE INVENTION

1. Field of the Invention

The present invention relates generally to apparatus and methods for the treatment of constipation and to release built-up intestinal gases and particularly to a vibrator for treatment of these conditions.

2. Description of the Related Art

Constipation is an ailment that affects millions of people every year. According to the National Institute of Health, 10% of the overall general population suffer from chronic constipation. A much greater percentage of certain groups of people suffer from constipation. For example, about 20-30% of the elderly population and about 50% of nursing home inhabitants take daily medication to treat constipation. In addition, over 60% of persons with multiple sclerosis, Parkinson's disease, diabetes, and cancer also take medication to treat constipation.

Constipation can be caused by a variety of reasons, such as a diet low in natural fibers, lack of fluids, lethargic physical activity, medications which slow intestinal activity or dry excreta found in the bowels, irritable bowel syndrome (IBS), laxative overdose, ignorance of the importance of regular bathroom habits, certain diseases which affect digestive and/or sphincter muscles, and disorders in the lower gastrointestinal tract. Complications arising from constipation include, for example, fecal impaction, infections, and lack of bowel control and possible damage to the lower gastrointestinal tract.

The build up of intestinal gases whether associated with constipation or independent can be not only embarrassing but have deleterious effect on health, including possible damage to the lower gastrointestinal tract.

Vibratory appliances for enhancement of removal of solutes during peritoneal dialysis treatment of a patient are known from the present applicant's published PCT patent application WO 97/04820. Furthermore, U.S. Pat. Nos. 4,051,560 and 4,920,583 disclose vibrating toilet seats designed to ease constipation. However, despite these efforts, an apparatus for providing local vibratory stimulation of the abdomen and bowels are unknown. Therefore, it is desirable to have a method and apparatus for the treatment of constipation and/or to effectuate the release of intestinal gases.

### SUMMARY OF THE INVENTION

The present invention seeks to provide novel apparatus and methods for the treatment of constipation and effectuating the release of intestinal gases by means of local vibratory stimulation of the abdomen and bowels. Vibratory stimulation of the abdominal area causes peristaltic movement of the gastrointestinal muscles, and encourages the increased circulation of blood to the gastrointestinal tract, thereby easing constipation and releasing gases. Vibrations between about 0.1 Hz to about 15 Hz simulate the natural peristaltic movement and are preferred. Such vibrations tend to relax the patient and to promote blood flow to the gastrointestinal system and may therefore increase the effectiveness of the treatment.

One preferred embodiment of the invention includes one or more vibrators, which cause vibratory movement of a patient's abdomen or gastrointestinal tract in a variety of vibratory modes. The vibratory modes can be optimized to suit the patient's needs. The patient can be treated in any position, e.g., sitting, reclining, and lying prone (face down) or supine (face up).

Advantages of the present invention over the prior art include, inter alia:

1. The local vibratory stimulation successfully moves the bowels and/or effectuates the release of intestinal gases without any need for laxatives or other medication.

2. Since the treatment is local, there are little, if any, side effects on the body.

3. There is no known danger of addiction to the vibratory stimulation as opposed to medications, which pose such a potential danger.

4. The vibratory stimulation can be applied as an additional treatment to medications, if desired, and may be used to gradually wean the patient away from medication.

5. The vibratory stimulation involves a one-time investment and is significantly less expensive than the use of medications over the long run.

There is thus provided in accordance with a preferred embodiment of the present invention apparatus for treatment of constipation and/or effectuating the release of intestinal gases, including a support member, at least one vibratory element attached to the support member, and an actuator operatively attached to the at least one vibratory element which moves the at least one vibratory element in a motion which is operative to promote peristaltic movement of gastrointestines so as to ease constipation of a patient.

In accordance with a preferred embodiment of the present invention, the support member includes a cushion adapted to be placed on a gastrointestinal area of the patient, and the at least one vibratory element includes a plate arranged to vibrate generally in a direction away from and towards the cushion.

Further, in accordance with a preferred embodiment of the present invention, the support member includes a backrest adapted to be placed on a back of a patient, the actuator includes a pulling mechanism and the at least one vibratory element includes at least one strap attached to the pulling mechanism, the at least one strap being arranged to be pulled across and vibrate against a gastrointestinal area of a patient.

Still further in accordance with a preferred embodiment of the present invention, the pulling mechanism vibrates the at least one strap in a side-to-side direction with respect to a gastrointestinal area of a patient.

Additionally, in accordance with a preferred embodiment of the present invention, the at least one strap has a stiffness which varies along a length thereof.

In accordance with a preferred embodiment of the present invention, one end of the at least one strap is stiffer than an opposite end thereof.

Further in accordance with preferred embodiment of the present invention, a pair of the straps is operatively connected to a pair of the actuators wherein each actuator vibrates the strap independently of the other actuator and strap.

Still further in accordance with a preferred embodiment of the present invention, the support member includes a frame including a fastener for securing the frame to a wheel chair and an adjustment arm adjustably attached to the frame on which is attached the at least one vibratory element.

There is also provided in accordance with a preferred embodiment of the present invention apparatus for vibration of a patient, including a support member adapted to be placed on a gastrointestinal area of the body of a patient, at least one vibratory element attached to the support member, and an actuator operatively attached to the at least one vibratory element which is operative to move the at least one vibratory element in a side-to-side, wave-like motion with respect to the body of the patient.

There is also provided in accordance with a preferred embodiment of the present invention a method for treatment of constipation and/or effectuating the release of intestinal gases, including providing at least one vibratory element, providing an actuator operatively attached to the at least one vibratory element, placing the at least one vibratory element on a body of patient near gastrointestines thereof, and operating the actuator to move the at least one vibratory element in a motion which promotes peristaltic movement of the gastrointestines so as to ease constipation of the patient.

In accordance with a preferred embodiment of the present invention the step of placing includes placing the at least one vibratory element against a front portion of the body.

Further, in accordance with a preferred embodiment of the present invention, the actuator moves the at least one vibratory element in a side-to-side, wave-like direction with respect to the gastrointestines.

### BRIEF DESCRIPTION OF THE DRAWINGS

The present invention will be understood and appreciated more fully from the following detailed description taken in conjunction with the drawings in which:

FIGS. 1, 2 and 3 are simplified pictorial, side-view and top-view illustrations, respectively, of apparatus for treatment of constipation and effectuating the release of intestinal gases, constructed and operative in accordance with a preferred embodiment of the present invention;

FIGS. 4 and 5 are simplified pictorial illustrations of the apparatus of FIGS. 1-3 being used to treat patient in lying and sitting positions, respectively, in accordance with a preferred embodiment of the present invention;

FIGS. 6 and 7 are simplified top-view and front-view illustrations, respectively, of apparatus for treatment of constipation and effectuating the release of intestinal gases, constructed and operative in accordance with another preferred embodiment of the present invention;

FIGS. 8 and 9 are simplified pictorial illustrations of variations of the apparatus of FIGS. 6 and 7; and

FIGS. 10, 11 and 12 are simplified pictorial, side-view and top-view illustrations, respectively, of apparatus for treatment of constipation and effectuating the release of intestinal gases constructed and operative in accordance with still another preferred embodiment of the present invention.

### DETAILED DESCRIPTION

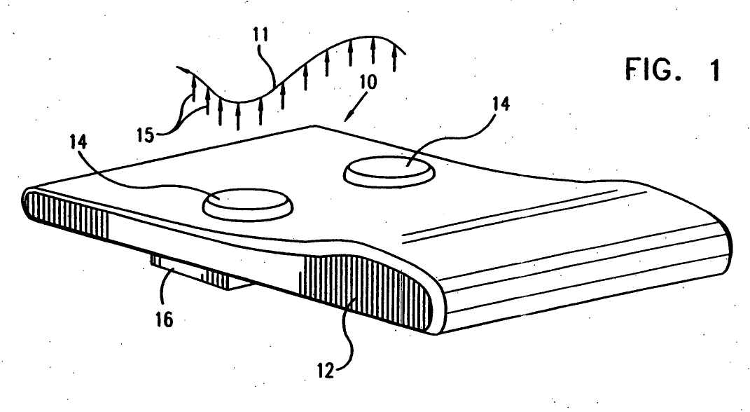

Reference is now made to FIGS. 1, 2 and 3, which illustrate apparatus 10 for treatment of constipation and/or effectuating the release of intestinal gases, constructed and operative in accordance with a preferred embodiment of the present invention.

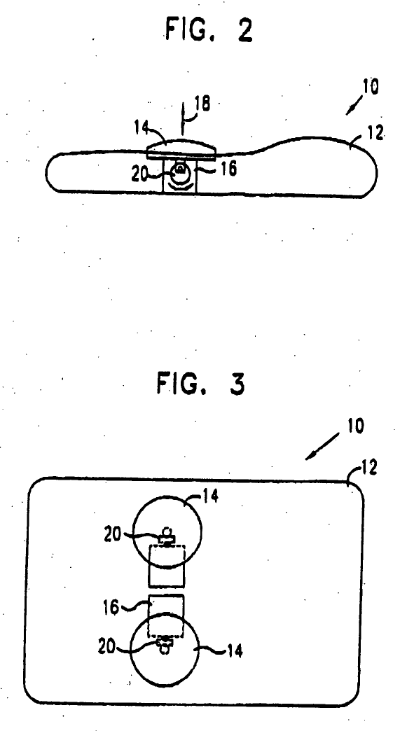

Apparatus 10 preferably includes a support member 12, preferably a cushion with a shape contoured to match an abdomen or back of a patient. One or more vibratory elements 14 are attached to support member 12, such as plates or cup-like members, preferably padded with a soft material. An actuator 16 is operatively attached to each vibratory element 14 which moves the vibratory elements 14 generally in a direction away from and towards the support member 12 (i.e., anterior-posterior motion), as shown by an arrow 18 in FIG. 2. Actuator 16 may be any kind of servomotor, for example, and may include an eccentric mechanism 20 for imparting the vibratory reciprocating motion to vibratory element 14.

This reciprocal, generally anterior-posterior motion which respect to the body, promotes peristaltic movement of gastrointestines so as to ease constipation and/or to effectuate the release of intestinal gases of a patient. Alternatively, vibratory elements 14 may be moved in a wave-like motion across the body, as shown in an arrow 11 in FIG. 1, which also promotes peristaltic movement of gastrointestines so as to ease constipation of a patient. The wave-like motion may be achieved by synchronizing the motion of each vibratory element 14, so that instead of both elements 14 moving together anterior-posterior, there is a phase shift between the motion of the two elements, such that the two elements generate a wave-like or sine-curve-like motion, as shown by arrows 15 in FIG. 1. A rocking motion of each element 14, depending on the type of mechanism 20, for example, can also achieve the wave-like motion.

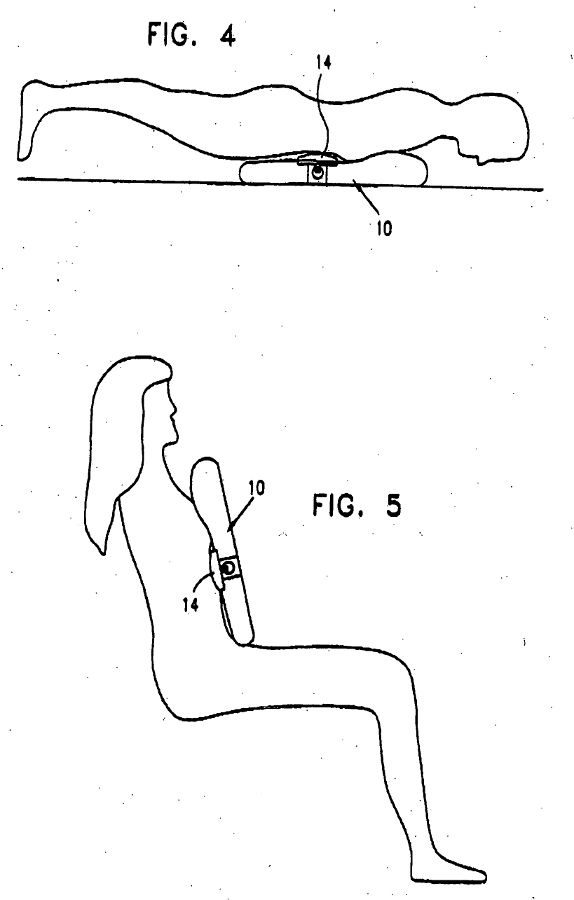

As seen in FIGS. 4 and 5, apparatus 10 can be placed against gastrointestines of a patient, while the patient is in a lying or sitting positions. Vibration of vibratory elements 14 against the gastrointestines promotes peristaltic movement thereof so as to ease constipation of the patient.

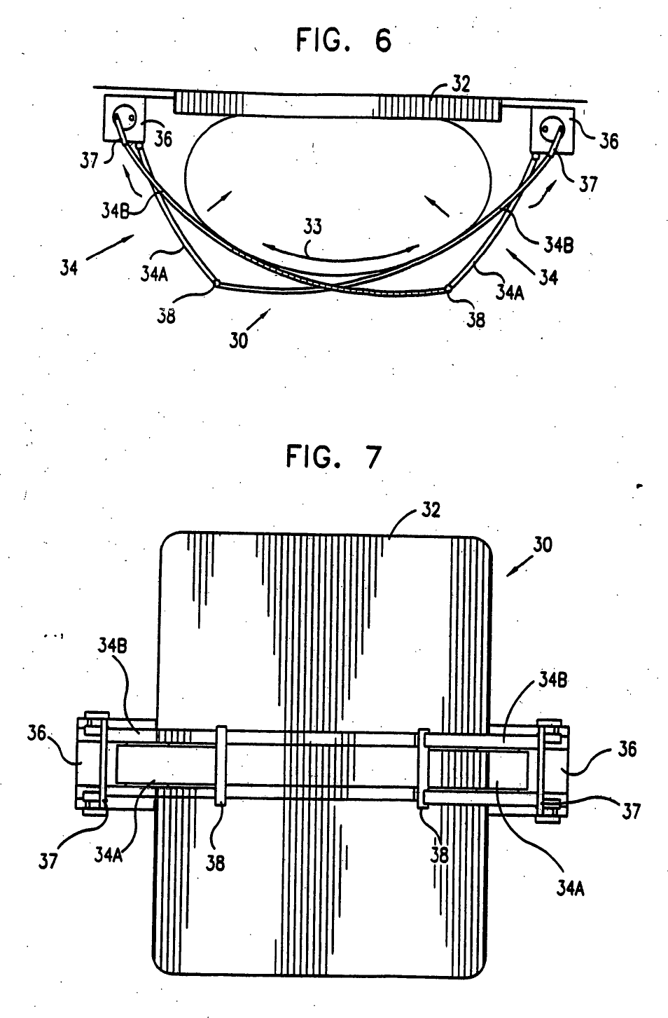

Reference is now made to FIGS. 6, 7 and 8, which illustrate apparatus 30 for treatment of constipation and/or effectuating the release of intestinal gases, constructed and operative in accordance with another preferred embodiments of the present invention.

Apparatus 30 preferably includes a support member 32, preferably a backrest adapted to be placed on a back of a patient. One or more vibratory elements 34 are attached to the support member 32 via one or more actuators 36. Actuators 36 preferably include a pair of pulling mechanisms 37, such as an eccentric mechanism or a solenoid mechanism, attached to sides of support member 32. Vibratory elements 34 preferably include a pair of straps arranged to be pulled across and vibrate against a gastrointestinal area of the patient. Each actuator 36 preferably vibrates each strap independently of the other actuator and strap. Pulling mechanisms 37 vibrate vibratory elements 34 in a side-to-side direction with respect to a gastrointestinal area of a patient, as indicated generally by an arrow 33 in FIG. 6. This reciprocating squeezing motion promotes peristaltic movement of gastrointestines so as to ease constipation and/or to effectuate the release of gases of a patient.

In the embodiments illustrated in FIGS. 6 and 7, the straps comprise two parts, a semi-rigid portion 34A and a somewhat flexible belt 34B. One end of semi-rigid portion 34A is attached to one of the pulling mechanisms 37 and the other end of semi-rigid portion 34A is attached to belt 34B via a lockable jointed connection 38. In this manner, strap 34 has a stiffness, which varies along a length thereof, and one end of strap 34 is stiffer than an opposite end thereof. It is appreciated, of course, that the stiffness of straps 34 can vary in other ways as well, or may be generally constant along a length thereof. The varying or non-varying stiffness can be used advantageously to squeeze different portions of the gastrointestinal area of the patient with different force as the straps are pulled against the patient so as to optimize the treatment plan.

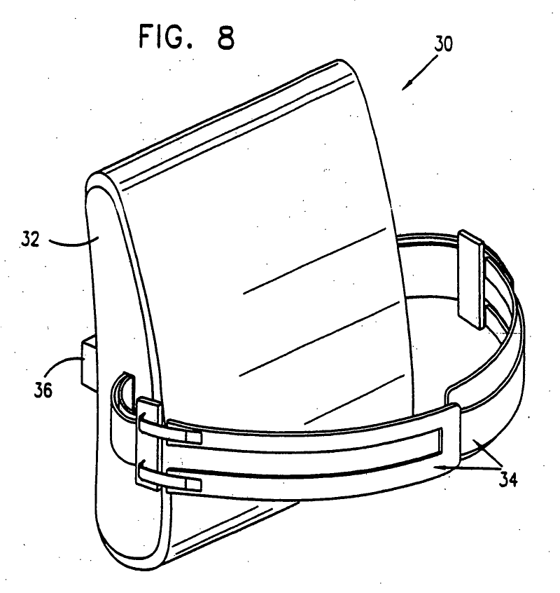

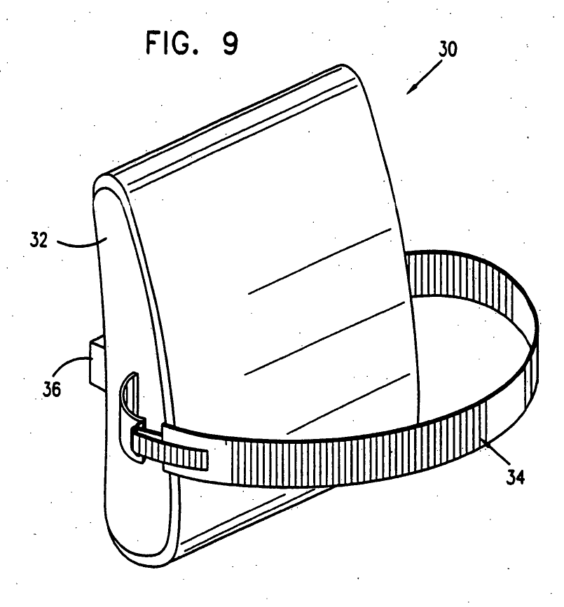

FIGS. 8 and 9 illustrate two different versions of the apparatus 30 of FIGS. 6 and 7. In FIG. 8, the vibratory elements 34 include two belts, whereas in FIG. 9, the Vibratory elements 34 include on belt.

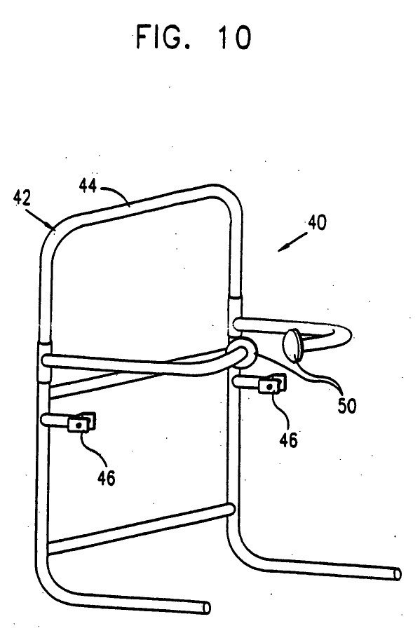

Reference is now made to FIGS. 10, 11 and 12, which illustrate apparatus 40 for treatment of constipation, constructed and operative in accordance with still another preferred embodiments of the present invention.

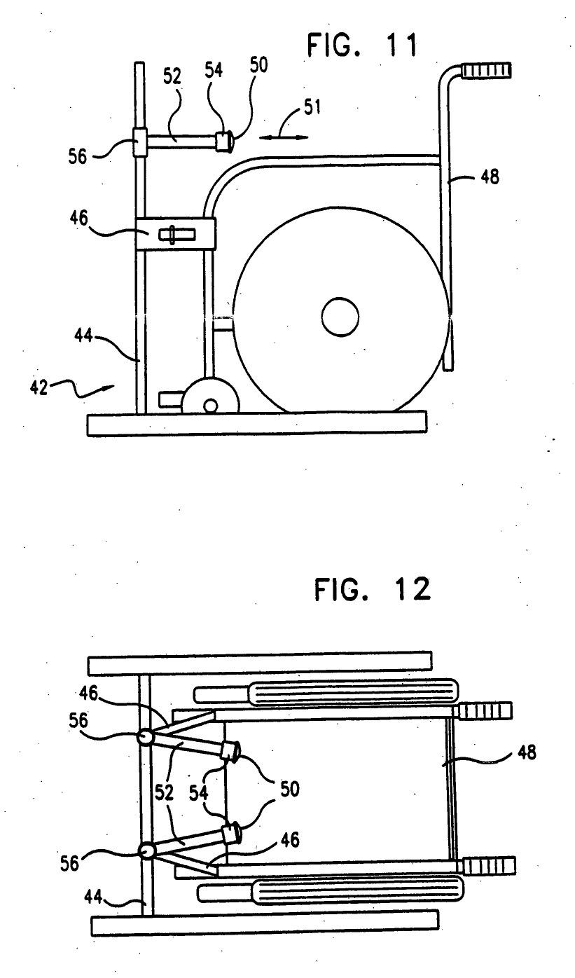

Apparatus 40 preferably includes a support member 42, preferably a frame 44 comprising a fastener 46 for securing frame 44 to a wheel chair 48. A pair of vibratory elements 50 is attached to an adjustment arm 52, which is adjustably attached to frame 44. Vibratory elements 50 may include cup-like members, preferably padded with a soft material. An actuator 54 is operatively attached to each vibratory element 50 which moves the vibratory elements 50 generally in a direction away from and towards a patient (not shown), as indicated by an arrow 51 in FIG. 11. This reciprocal motion promotes peristaltic movement of gastrointestines so as to ease constipation of a patient and effectuate the release of intestinal gases of the patient. Actuator 54 may be any kind of servomotor or solenoid mechanism, for example, for imparting the vibratory reciprocating motion to vibratory element 50.

Fastener 46 may be a fastening belt suitable for securing frame 44 to wheelchair 48. A locking device 56 may be provided for locking adjustment arm 52 in place along frame 44.

Two sets of clinical tests using the vibratory apparatus of the present invention were run on nine patients. The first set of tests included treating four kidney dialysis patients for six weeks. The treatment included three 20-minute sessions per day, as not to exceed one hour per day in accordance with the requirements of ISO 2631. The treatment included sitting on the apparatus, closing the arms such that the vibratory elements touched the patient's abdomen, applying vibration for 15-20 minutes, and releasing the patient from the apparatus. The apparatus was adjusted in accordance with the patient's body such that the vibratory elements touched the patient on opposite sides of the abdomen at approximately an angle of 45° from the anterior-posterior body axis. The treatment sessions were carried out in the morning, noon and evening. Although the patients were peritoneal dialysis patients, the constipation vibratory treatment was almost always performed without any dialytic solution in the abdomen.

Good results were obtained after only one or two weeks from the initial treatment. The following Table A summarizes the results of the treatment;

TABLE A

| Patient ID | | | | |
|---|---|---|---|---|
| No. | Sex | Frequency (Hz) | Before | After |
| 31 | Male | 1.75 | One BM* per | One BM per day |
| | | | week | |
| 32 | Male | 1.75 | One BM per day | One BM per day |
| | | | with medication | without any |
| | | | taken 3 times per | medication |
| | | | day | |
| 33 | Male | 1.5 | 4-5 BMs per | 8-10 BMs per |
| | | | week | week |
| 34 | Male | 1.5 | One BM per four | One BM per day |
| | | | days | |

*Bowel Movement

In the second clinical test, the vibratory apparatus of the present invention was run on five patients using the same parameters as the first clinical test. However, these five patients were not kidney dialysis patients. Once again, good results were obtained after only one to two weeks from the initial treatment. The following Table B summarizes the results of the treatment:

| | | Average | | | |
|---|---|---|---|---|---|
| | | # of | | | |
| Patent | Average # of | BM at | Medication | Change in | Time on |
| ID# | BM - Control | ROC | Change | Evacuation | ROC |
| 111 | 1.4 | 3 | Terminated | H-S | 8 weeks |
| 112 | 1.2 | 6.75 | Terminated | L, H-R | 8 weeks |
| 113 | 1.2 | 3.25 | Terminated | H-S | 8 weeks |
| 114 | 2.6 | 7.25 | Terminated | H-S | 8 weeks |
| 115 | 1 | | | | 0 weeks |

BM—Bowel Movement
S—Soft Stool
R—Regular
H—Hard Stool
L—Low Amount
ROC—Relief of Constipation

It should be noted that the apparatus was tested on one individual, with no problems of constipation, for a total of one hour per day. The treatment increased the number of bowel movements from 1-2 per day to 5-6 per day.

Persons skilled in the art will appreciate that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. A method for treatment of a condition selected from the group consisting of constipation and build up of intestinal gases comprising:
providing at least one vibratory element;
providing an actuator operatively attached to said at least one vibratory element;
placing said at least one vibratory element on a body of a patient near gastrointestines thereof; and
operating said actuator to move said at least one vibratory element in a motion, which promotes peristaltic movement of the gastrointestines so as to alleviate said condition in said patient.

2. The method according to claim 1 wherein the step of placing comprises placing said at least one vibratory element against a front portion of the body.

3. The method according to claim 1 wherein said actuator moves said at least one vibratory element in a side-to-side, wave-like direction with respect to the gastrointestines.

4. The method according to claim 1 further comprising providing a pair
of said actuators and vibratory elements, wherein each actuator and vibratory element
vibrates independent of the other actuator and vibratory element.
